(19) United States
(12) Patent Application Publication
(10) Pub. No.: US 2019/0306169 A1
(43) Pub. Date: Oct. 3, 2019

(54) SYSTEM AND METHOD FOR MANAGING ACCESS TO STORED OBJECTS

(71) Applicant: Microsoft Technology Licensing, LLC, Redmond, WA (US)

(72) Inventors: Jeromy S. Statia, Arlington, WA (US); Xiaodong Wang, Snoqualmie, WA (US)

(21) Appl. No.: 15/937,643

(22) Filed: Mar. 27, 2018

(51) Int. Cl. H04L 29/06; H04L 29/08

(52) U.S. Cl. CPC H04L 63/102; H04L 63/0853; H04L 67/42; H04L 67/1097; H04L 63/108

(57) ABSTRACT

Methods, systems, and apparatuses for managing access to a stored object/resource are provided. A shared access credential service may manage access attempts to the stored object by a client. A first request is received by the service from the client. The first request includes an authorization token. Whether an application in the client is authorized to access the stored object based upon the authorization token is determined. In response to determining the application to be authorized to access the stored object, (a) a shared access credential is generated to replace a prior-generated shared access credential (if existing) associated with the stored object, (b) the replacement shared access credential is associated with the stored object, and (c) the replacement shared access credential is provided by the service to the client. The replacement shared access credential is configured to be presented by the application to enable access to the stored object.

### BACKGROUND

File syncing and sharing services are file hosting services that automatically synchronize folders and their contents over multiple computing devices. A user may create a folder on each of their computing devices. The file synching service synchronizes the folders such that synchronized copies of the same folder appear on each of the computing devices. Furthermore, a copy of the folder may be maintained at the file synching service itself, which the user may access using a web browser or other application. Files placed in the folder may also be easily shared with other users for viewing or collaboration. Examples of such file synching services include Dropbox®, Google® Drive™, and Microsoft® OneDrive®.

A stored file in the folder may be accessed at a computing device of the user, referred to as a “client.” To fulfill the access attempt, the client may request a copy of the stored file from the file synching service at a server. The client request may include a token to identify the client as authorized to access the stored file. In response, the server grants access to the client based on the token, and transmits the requested file to the client. Any entities that obtain the token may be enabled to access the file from the server by using the token, including entities that obtained the token via illicit means.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and apparatuses for managing access to a stored object/resource are provided. A shared access credential service may manage access attempts to the stored object by a client. A first request is received by the service from the client. The first request includes an authorization token. Whether an application in the client is authorized to access the stored object based upon the authorization token is determined. In response to determining the application to be authorized to access the stored object, (a) a shared access credential is generated to replace a prior-generated shared access credential (if existing) associated with the stored object, (b) the replacement shared access credential is associated with the stored object, and (c) the replacement shared access credential is provided by the service to the client. The replacement shared access credential is configured to be presented by the application to enable access to the stored object.

Furthermore, a second request is received by a network-based storage service from the client. The second request includes the replacement shared access credential and is an attempt to access the stored object. The application is determined by the network-based storage service to be authorized to access the stored object based on the replacement shared access credential. The stored object is provided by the network-based storage service to the client to provide to the application.

Further features and advantages of the systems and methods, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present methods and systems and, together with the description, further serve to explain the principles of the methods and systems and to enable a person skilled in the pertinent art to make and use the methods and systems.

FIGS. 1A and 1B show block diagrams of systems for managing access to a stored object, in accordance with example embodiments

FIG. 2 is a flowchart of a server-side process for managing access to a stored object, in accordance with an example embodiment.

FIG. 3 is a block diagram of a system for managing access to a stored object, in accordance with an example embodiment.

FIG. 4 is a flowchart of a process for evaluating conditions associated with a shared access credential with respect to an object access request, in accordance with another example embodiment.

FIG. 5 is a flowchart of a process of applying conditions for access to a stored object by a shared access credential, in accordance with another example embodiment.

FIG. 6 is a flowchart of a client-side process for requesting a replacement shared access credential, in accordance with an example embodiment.

FIG. 7 shows a network-based storage service configured for managing access to stored objects, in accordance with an example embodiment.

FIG. 8 depicts an example processor-based computer system that may be used to implement various embodiments described herein.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### Introduction

The present specification and accompanying drawings disclose one or more embodiments that incorporate the features of the present methods and systems. The scope of the present methods and systems is not limited to the disclosed embodiments. The disclosed embodiments merely exemplify the present methods and systems, and modified versions of the disclosed embodiments are also encompassed by the present methods and systems. Embodiments of the present methods and systems are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

The example embodiments described herein are provided for illustrative purposes, and are not limiting. The examples described herein may be adapted to any type of method or system for managing access to objects. Further structural and operational embodiments, including modifications/alterations, will become apparent to persons skilled in the relevant art(s) from the teachings herein.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### Example Embodiments

Methods and systems described herein enable the accessing of stored objects (e.g., resources) that are secured with a shared access credential. As referred to herein, a “shared access credential” is a type of access token that may be provided by an entity to show the entity as authorized to access stored objects secured by the shared access credential, such as objects stored as owned by a particular user and accessible using a particular application for which the shared access credential is generated. A shared access credential is shareable, in that any entity that possesses the shared access credential can access the stored object(s) secured by the shared access credential, subject to one or more conditions that may optionally be associated with the shared access credential. Shared access credentials can have various forms, including a certificate, a string-based password, a token, a credential of user name and password, a Microsoft® Azure® shared access signature, and other format of data structure that can be inserted in a request to a storage service that stores the secured object(s), and that can be shared as mentioned above.

The terms “objects” and “resources” are used interchangeably herein to refer to stored objects, such as files, folders, etc. Embodiments may be applied to any type of file sharing/synching services and environments, and their corresponding stored object types and techniques for synchronizing them. For example, there are numerous Microsoft® Azure® stored objects that exist in the Azure® SDK (software development kit), such as “Queue”, “Blob,” “Table”, “File”, etc. In embodiments, shared access credentials may be used to grant access to these and further types of stored objects in corresponding storage accounts.

The use of a shared access credential provides granular control over what type of access clients are granted. For example, conditions can be placed on a shared access credential, such as a condition to limit the time interval over which the shared access credential is valid, including the start time and the expiration time. The permissions granted by the shared access credential can also be limited such that the client can only perform certain actions with respect to the accessed entity. For example, a shared access credential on an object might grant a user read and write permissions to that object, but not delete permissions. Access to a stored object can also be limited to an IP address or range of IP addresses from which the storage service will accept the shared access credential. For example, a range of IP addresses belonging to an organization may be specified. This provides an additional measure of security. Access can also be limited to a specified protocol over which the storage service will accept the shared access credential. For example, this optional parameter can be used to restrict access to clients using the HTTPS protocol. Optional conditions/parameters/constraints can also include a condition that specifies the storage service version to use to execute the request or specifies the storage service version to use to authenticate the request. The condition can specify an IP address or a range of IP addresses outside from which to accept requests.

In an embodiment, a shared access credential may have the form of a uniform resource identifier. In such case, anyone that obtains the shared access credential can use it, regardless of who originally created it. If a shared access credential is published publicly, it can be used by anyone. As a result, in an embodiment, for security reasons, a shared access credential token may be assigned a limited amount of time to be valid (e.g., in terms of hours, minutes, seconds, milliseconds, etc.). Further, a shared access credential may be renewed before its expiration (e.g., renewed at a predetermined portion of the full expiration time interval), to allow time for retries if the service renewing and providing the secured access credential is unavailable. If the shared access credential is meant to be used for a small number of immediate, short-lived operations that are expected to be completed within the expiration period, such renewal may be unnecessary. However, if the client is routinely making requests via a shared access credential, then the possibility of expiration is more likely. A key consideration is to balance the need for the shared access credential to be short-lived with the need to ensure that the client is requesting renewal early enough to avoid disruption due to the shared access credential expiring prior to successful renewal.

In accordance with an example embodiment, a client-side shared access credential manager may automatically refresh their shared access credential(s) with a shared access credential service when detecting the shared access credential(s) as about to expire, at periodic intervals, and/or according to any other schedule or criteria. One example default time for replacement of the shared access credential can be defined as the expiration of half (or other portion) of the shared access credential's valid time interval. The use of shared access credentials with configurable attributes, such as a refresh period, provides advantages. For instance, a developer using an automatically refreshable shared access credential is not required to implement their own programming logic to periodically refresh the shared access credential.

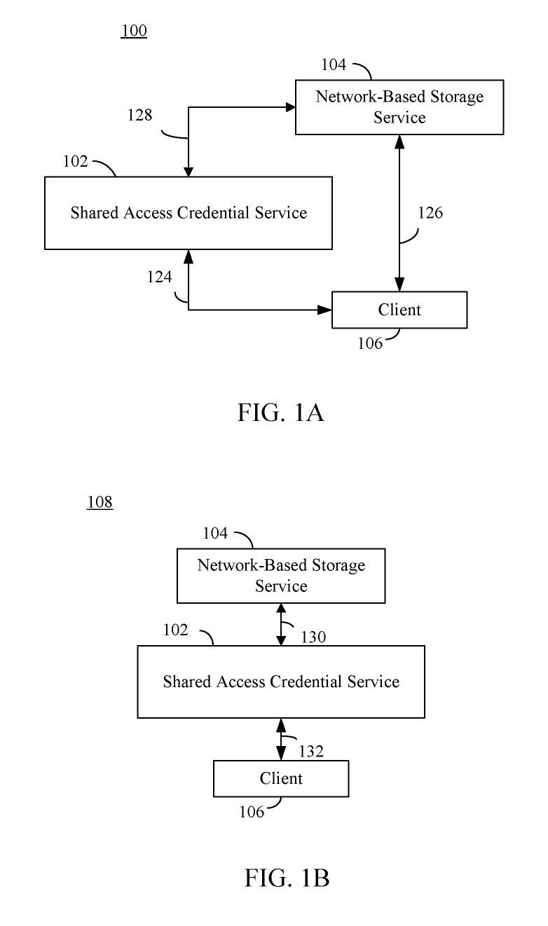

Access to a stored object secured with a refreshable shared access credential may be managed in various manners. For example, FIG. 1A is a block diagram of a storage access management system 100 for managing access to a stored object, in accordance with an embodiment. As shown in FIG. 1A, system 100 includes a shared access credential (SAC) service 102, a network-based storage (NBS) service 104, and a client 106. A communication channel 124 communicatively couples client 106 and storage access credential service 102. A communication channel 126 communicatively couples client 106 and NBS service 104. A communication channel 128 communicatively couples storage access credential service 102 and NBS service 104. Communication channels 124, 126, and 128 may be physically separate channels, or may share one or more common links (e.g., be integrate in a network). These features of system 100 are described as follows.

Client 106 generates requests for objects stored at NBS service 104. Client 106 may be a personal computer, mobile device, virtual machine or any other type of computing device or application mentioned elsewhere herein or otherwise known, that accesses objects over a network. Client 106 transmits requests for the objects to SAC service 102 through communication channel 124. Client 106 may include an authorization token in the request for a stored object. As set forth herein, the stored object may be any kind of storable object such as a queue, blob (unstructured text and binary data), table, file, etc. Note that although FIG. 1A shows a single client 106, any number of clients may communicate with SAC service 102 and network-based serve 104 to retrieve copies of objects stored at NBS service 104, including tens, hundreds, thousands, millions, and even greater number of clients.

SAC service 102 is configured to receive and facilitate requests for stored objects received through communication channel 124 from client 106 and provide newly-generated shared access credentials to client 106 and NBS service 104 through respective communication channels 124 and 128. In response to receiving the request, SAC service 102 validates the request (e.g., by determining an authorization token included in the request authorizes the sending client/application to access the data object), generates a storage access credential that may be used to access the stored object, associates the generated storage access credential with the stored object, and transmits the shared access credential to client 106 over communication channel 124. The generated storage access credential may be a replacement for a prior-generated shared access credential previously received by client 106 for accessing the stored object. In an embodiment, SAC service 102 may forward the request for the object along with information regarding newly-generated shared access credentials directly to NBS service 104. SAC service 102 may be based in a remote server, including being hosted in a cloud service, or being otherwise appropriately located. Note that in another embodiment, SAC service 102 may request NBS service 104 to generate the shared access credential, may receive the generated shared access credential from the NBS service 104, and provide the shared access credential to client 106.

NBS service 104 is configured to manage access to objects that are secured with shared access credentials. NBS service 104 may be hosted on a server, personal computer, virtual machine or any other type of computing device or application. NBS service 104 may receive requests for stored objects secured with shared access credentials from client 106 through communication channel 126. For example, client 106 may transmit the shared access credential received from SAC service 102 in a request for the stored object. Based on a determination that the request includes a valid shared access credential (e.g., matches a shared access credential maintained by NBS service 104), NBS service 104 transmits the stored object to client 106, or otherwise enables access to the stored object by the application at client 106 according to any relevant conditions associated with the shared access credential (e.g., one or more permissions such as create, update, delete, etc.).

The replacement of the prior-generated shared access credential with a replacement shared access credential as described herein may be performed without interrupting access to the object by the application in a manner that is transparent. In other words, the application may request access to the object, and in the process of gaining such access, the prior-generated shared access credential may be replaced with the replacement shared access credential, which is used to access the object. The application need not be aware that a shared access credential exists, has been replaced, and the replacement version is used to access the object.

Note that in the embodiment of FIG. 1A, client 106 receives a storage access credential from stored access credential service 102, provides the stored access credential directly to NBS service 104 with a request for the stored object, and receives the stored objected directly from NBS service 104. Alternatively, the stored object may be provided from NBS service 104 through stored access credential service 102. For instance, FIG. 1B is a block diagram of a storage access management system 108 for managing access to a stored object in accordance with another embodiment. As shown in FIG. 1B, system 108 includes a SAC service 102, a NBS service 104, and a client 106. A communication channel 132 communicatively couples client 106 and storage access credential service 102. A communication channel 132 communicatively couples storage access credential service 102 and client 106. Communication channels 130 and 132 may be physically separate channels, or may share one or more common links (e.g., be integrated in a network). System 108 is described as follows.

As described above, client 106 generates a request for an object stored in NBS service 104. In FIG. 1B, client 106 transmits the request to SAC service 102 through communication channel 132. In response to receiving the request, and as described above, SAC service 102 validates the request, generates a storage access credential that may be used to access the stored object, and associates the generated storage access credential with the stored object. The generated storage access credential may be a replacement for a prior-generated shared access credential previously received by client 106 for accessing the stored object. Furthermore, storage access credential service 102 transmits a request for the requested object, with the shared access credential, to NBS service 104 through communication channel 130. In response to a determination that the request from SAC service 102 includes a valid shared access credential, NBS service 104 transmits the stored object to SAC service 102 over communication channel 130. SAC service 102 then transmits the secured object to client 106 over communication channel 132.

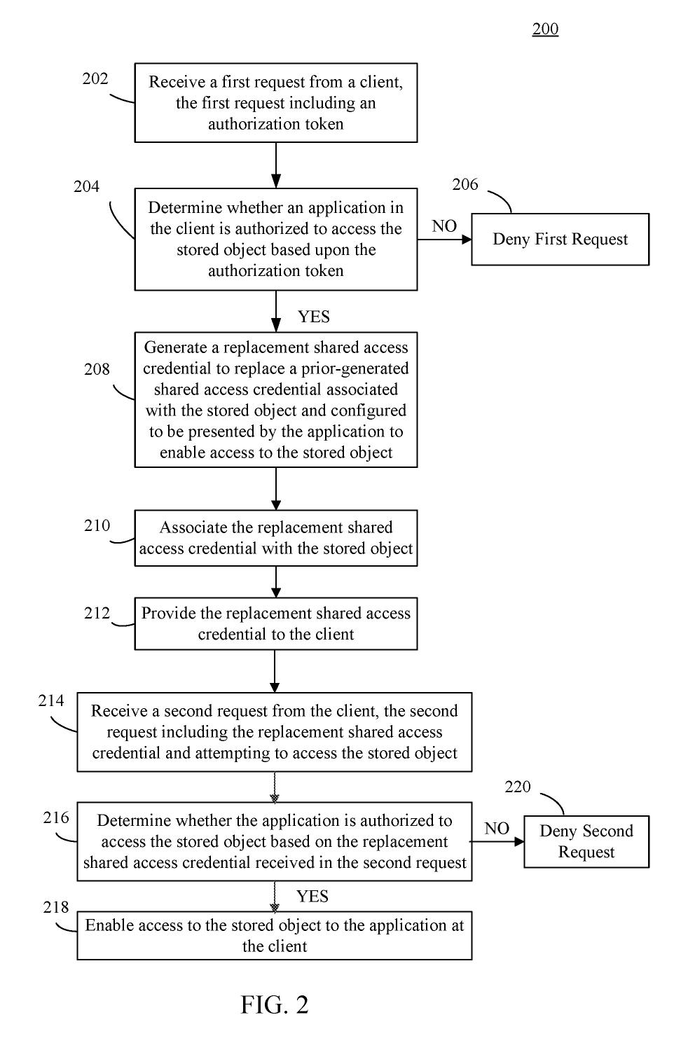

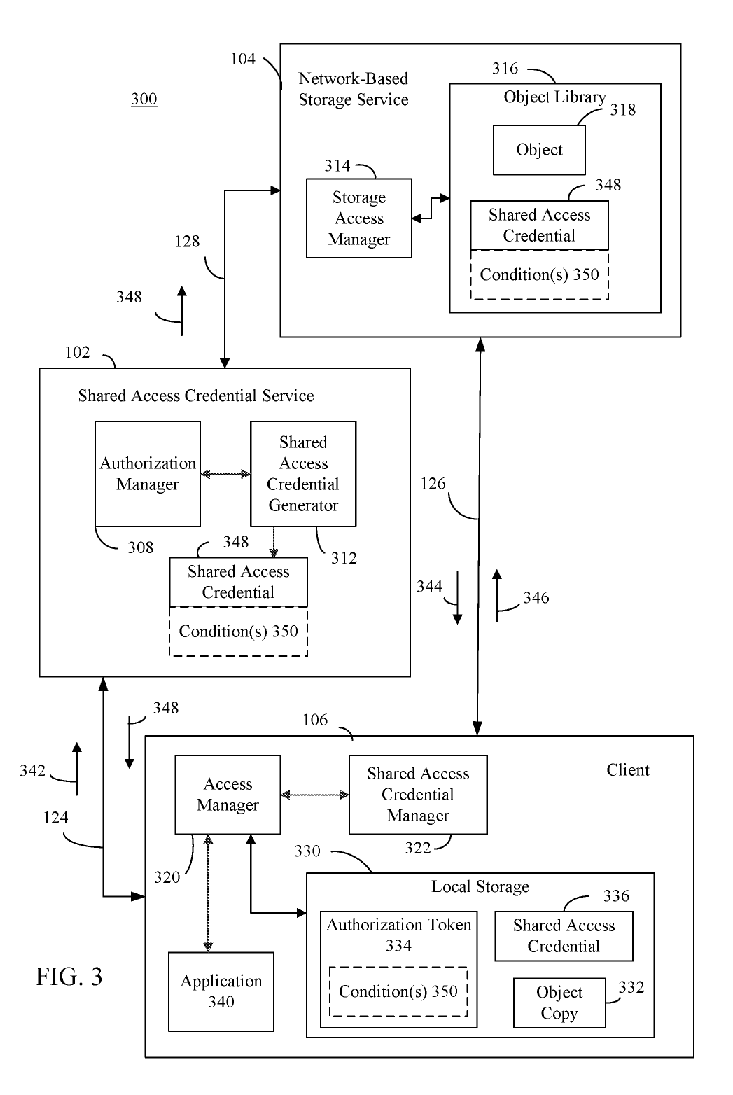

The components of systems 100 and 108 may be configured in various ways, and may operate in various ways to perform their functions. For instance, FIG. 2 is a flowchart 200 of a server-side process of managing access to a stored object in accordance with an example embodiment. Flowchart 200 may be performed by SAC service 102 of each of systems 100 and 108. Flowchart 200 is described as follows with respect to FIG. 3. FIG. 3 is a block diagram of a system 300 for managing access to stored objects in accordance with an example embodiment. System 300 is an example of system 100 of FIG. 1A, though components of system 108 in FIG. 1B may be configured as shown in FIG. 3. As shown in FIG. 3, system 300 includes SAC service 102, NBS service 104, and client 106, which are communicatively coupled by communication channels 124, 126, and 128 as described above with respect to FIG. 1A (although the embodiment of FIG. 3 is adaptable to the configuration of FIG. 1B as well). SAC service 102 includes an authorization manager 308 and a shared access credential (SAC) generator 312. NBS service 104 includes a storage access manager 314 that controls access to an object library 316. Object library 316 stores an object 318 and an associated shared access credential 348. Client 106 includes an access manger 320, a shared access credential (SAC) manager 322 and a local storage 330. In FIG. 3, local storage 330 stores an authorization token 334, an object copy 332, and an associated shared access credential 336.

Although flowchart 200 is described as follows with reference to various components of system 300, it will be appreciated that the method of flowchart 200 may be performed by other structural embodiments.

Flowchart 200 begins with step 202. In step 202, a first request is received from a client, the first request including an authorization token. In an embodiment, step 202 may be performed by SAC service 102. In FIG. 3, application 340 may desire access to an object stored at NBS service 104. Application 340 may be any type of application capable of executing on a computing device (e.g., a word processing application, a spreadsheet application, a web browser, a media player, a mail application, etc.). As shown in FIG. 3, application 340 may attempt to access the stored object in local storage 330, access to which is managed by access manager 320. Access manager 320 may be any type file access manager, including a file-sharing/synching service client-side application, proprietary or commercially available, such as the Dropbox® client, Google® Drive™ client, Microsoft® OneDrive® client, etc. The desired object may not be stored in local storage 330 (or an old version may be stored). As such, access manager 320 is configured to generate a request 342 for the object that is transmitted from client 106 over communication channel 124 to the server-hosted side of the file-sharing/synching service, embodied in FIG. 3 by NBS service 104. Authorization manager 308 of SAC service 102 is configured to receive request 342 from client 106 for the object, network-based storage of which is managed by NBS service 104. Authorization token 334 is received in request 342 from client 106. As described above, authorization token 334 is a credential that indicates an entity (e.g., a user account running application 340 at client 106) is authorized to access an object. Authorization token 334 may comprise any particular form or format, including a character string or other data structure indicating client 106 is authorized to access the requested object.

In step 204, it is determined whether an application in the client is authorized to access the stored object based upon the authorization token. In an embodiment, step 204 can be performed by authorization manager 308. Authorization manager 308 is configured to determine whether authorization token 334 is valid (e.g., by matching received authorization token 334 with a copy thereof maintained by authorization manager 308). If it is determined that authorization token 334 is valid, flowchart 200 proceeds from step 204 to step 208. If authorization manager 308 determines that authorization token 334 is not valid, flowchart 200 proceeds from step 204 to step 206.

In step 206, the first request is denied. In an embodiment, step 206 can be performed by authorization manager 308 of FIG. 3. Request 342 is denied if authorization manager 308 determined in step 204 that client 106 (e.g., a user account at client 106 under which application 340 is running) is not authorized to access the storage object. The denial may be based on authorization token 334 not matching a copy of the authorization token maintained by authorization manager 308, authorization manager 308 determining authorization token 334 as expired or revoked, the request not satisfying a condition on use imposed by authorization token 334, and/or for any other reason deemed appropriate.

In step 208, a replacement shared access credential is generated to replace a prior-generated shared access credential associated with the stored object and is configured to be presented by the application to enable access to the stored object. In an embodiment, step 208 may be performed by SAC generator 312 of FIG. 3. SAC generator 312 is configured to, in response to the authorization manager 308 having determined client 106 to be authorized to access the stored object, generate a replacement shared access credential 348 configured to replace a prior-generated shared access credential (if existing) associated with the requested stored object. Replacement shared access credential 348 (similar to the one being replaced) is configured to be presented by access manager 320 of client 106 to NBS service 104 for subsequent access of the stored object.

Note that in an alternative embodiment, SAC generator 312 may be located at NBS service 104. In such an embodiment, authorization manager 308 at service 102 transmits a request over communication channel 128 to SAC generator 312 at NBS service 104 to generate replacement shared access credential 348. In response, SAC generator 312 generates and transmits replacement shared access credential 348 to authorization manager 308.

In step 210, the replacement shared access credential is associated with the stored object. In an embodiment, step 210 may be performed by storage access manager 314 of NBS service 104 shown in FIG. 3. Storage access manager 314 is configured to receive replacement shared access credential 348 from SAC generator 312 and associate replacement shared access credential 334 with stored object 318, which is the object requested by application 340. Storage access manager 314 may be any type of server-side file access manager, including a file-sharing/synching service server-side application, proprietary or commercially available, such as the server-side portions of Dropbox®, Google® Drive™, Microsoft® OneDrive®, etc. Note that replacement shared access credential 334 may replace a shared access credential 334 previously generated for, and associated with stored object 318. Storage access manager 314 may associate replacement shared access credential 334 with stored object 318 in any manner, including inserting replacement shared access credential 334 in stored object 318 (e.g., in a header, etc.), storing replacement shared access credential 334 in a table, array, database, or other data structure in association with an identifier for stored object 318, etc. Associating replacement shared access credential 348 with stored object 318 allows anyone possessing replacement shared access credential 348 to access stored object 318 according to any conditions (if any) associated with replacement shared access credential 348.

In step 212, the replacement shared access credential is provided to the client. In an embodiment, step 212 may be performed by SAC generator 312 of SAC service 102. Replacement shared access credential 348 is transmitted to client 106 by SAC service 102 over communication channel 124. The replacement of the prior-generated shared access credential with the first replacement shared access credential can be performed without interrupting access to the object by the application in a transparent manner such that a requesting application is unaware that the shared access credential for an associated object has been replaced.

After steps 202-212, access manager 320 may access stored object 318 at network-based storage service 106 by providing replacement shared access credential 348 with a request, subject to any conditions associated with replacement shared access credential 348. Furthermore, replacement shared access credential 348 may be shared with another entity to enable that entity to access stored object 318, as long as replacement shared access credential 348 does not expire and/or other conditions associated with replacement shared access credential 348 do not prevent such access.

For example, in step 214, a second request is received from the client, the second request including the replacement shared access credential and attempting to access the stored object. In an embodiment, step 214 may be performed by access manager 320, which generates a request 346 to NBS service 104 that includes replacement shared access credential 348. Storage access manager 314 at NBS service 104 receives request 346.

In step 216, whether the application is authorized to access the stored object is determined based on the replacement shared access credential received in the second request. Storage access manager 314 is configured to determine whether access manager 320 is authorized to access stored object 318 based on replacement shared access credential 348. If replacement shared access credential 348 is determined to be valid (e.g., received replacement shared access credential 348 matches the stored version in object library 316), operation proceeds to step 218. If replacement shared access credential 348 is determined to be invalid, operation proceeds to step 220.

In step 218, the stored object is enabled to be accessed by the application at the client. In an embodiment, step 218 may be performed by storage access manager 314 at NBS service 104. Storage access manager 314 accesses stored object 318 in object library 316. Object library 316 may contain any number and types of stored objects, including object 318 and associated shared access credential 348. Object 318 may be any type of storable object mentioned herein or otherwise known, such as a file, a folder, a queue, a table, etc. Any number of objects may be stored in object library 316, including numbers of stored objects in the tens, hundreds, thousands, millions, billions, and even greater numbers. Storage access manager 314 transmits stored object 318 to access manager 320 at client 106 in access request response 344, or otherwise enables access to stored object 318 according to one or more conditions associated therewith (e.g., create, update, delete, etc.).

In step 220, the second request is denied. In an embodiment, step 220 can be performed by storage access manager 314. Request 346 is denied if storage access manager 314 determined in step 216 that access manager 320 (e.g., on behalf of a user account at client 106 under which application 340 is running) is not authorized to access stored object 318. The denial may be based on replacement shared access credential 348 not matching a copy maintained by storage access manager 314, storage access manager 314 determining replacement shared access credential 348 as expired or revoked, request 346 not satisfying a condition on use imposed by replacement shared access credential 348, and/or for any other reason deemed appropriate.

Note that steps 214, 216, and 218 can be repeated any number of times for the same shared access credential, prior to the shared access credential timing out (and/or other conditions for the shared access credential expiring and/or being violated). For example, a third request may be generated by access manager 320 at client 106, transmitted, and the received by storage access manager 314 at NBS service 104, the third request including replacement shared access credential 348 and attempting to access stored object 318. Storage access manager 314 may again determine application 340 at client 106 is authorized to access stored object 318 based on replacement shared access credential 348 received in the third request, and therefore may provide stored object 318 to client 106 for receipt by application 340. This same process may be repeated any number of times using the same shared access credential until the shared access credential times out (the time interval for validity expires without renewal), other condition for validity and/or its use is violated, or a replacement for the shared access credential is generated (which causes the shared access credential to no longer be valid).

Note that communication channels 124, 126, 128, 130, and 132 can each be any type of suitable wireless and/or wired communication channels such as IP (Internet protocol), cellular, wi-fi, etc. For example, credential service 102, NBS service 104, and client 106 may each be included in a respective computing device (or respective set of computing devices) that are communicatively coupled via a network. The network may comprise any type of communication links that connect computing devices and servers such as, but not limited to, the Internet, wired or wireless networks and portions thereof, point-to-point connections, local area networks, enterprise networks, and/or the like.

As described above, a shared access credential may be constrained by one or more conditions on its use. Any number and type of conditions may be applied to constrain a shared access credential. Such conditions may be applied to a shared access credential in any manner, and may be enforced in various ways.

For instance, SAC manager 322 at client 106 may be configured to indicate in authorization token 334 one or more conditions to be applied to a replacement shared access credential. A user (e.g., a developer, a user who owns client 106, etc.) may be enabled to interact with a user interface of SAC manager 322 at client 106 to configure the conditions, SAC manager 322 may maintain default conditions to include in authorization token 334, and/or conditions may be provided in any other manner. When SAC generator 312 at SAC service 102 (or at NBS service 104) receives authorization token 334 from client 106, SAC generator 312 determines/extracts the one or more conditions as condition(s) 350 from authorization token 334, generates replacement shared access token 348, stores condition(s) 350 in association with shared access credential 348 (e.g., in storage associated with SAC service 102), and provides replacement shared access token 348 with condition(s) 350 to NBS 104 to be stored in object library 316. In this manner, SAC service 102 and NBS service 104 can each evaluate condition(s) 350 associated with SAC 348 as desired.

As described above, any number and type of condition may be included in condition(s) 350. For instance, condition(s) 350 may include one or more of: a time interval for which the replacement shared access credential is valid, a permission granted by the replacement shared access credential for access to the stored object, a network address (e.g., IP address) from which the stored object may be accessed using the replacement shared access credential, or a communication protocol by which the stored object may be accessed using the replacement shared access credential. Examples of permissions conditions that may be granted by the shared access credential including create/write, update/modify, and delete of the stored object that the shared access credential is associated with.

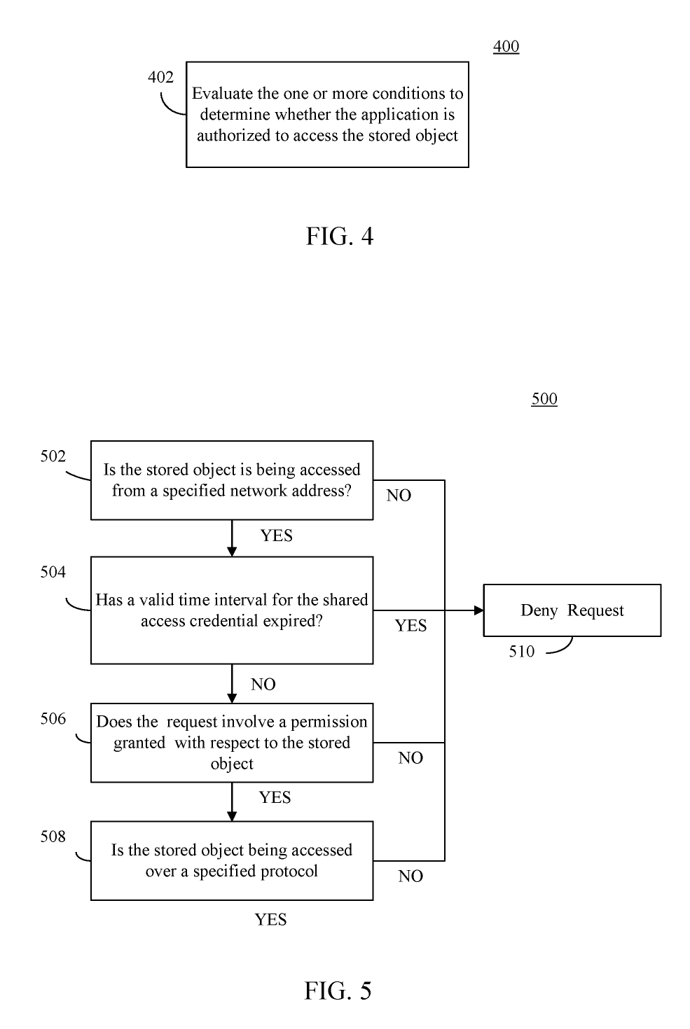

In an embodiment, SAC manager 334 at NBS service 104 may evaluate condition(s) 350 when receiving shared access credential 348 in a request to access stored object 318. For example, SAC manager 334 may operate according to FIG. 4. FIG. 4 is a flowchart 400 of a process for evaluating conditions associated with a shared access credential with respect to an object access request. In an embodiment, step 402 of FIG. 4 may be implemented during step 216 of flowchart 200 (FIG. 2).

In step 402, the one or more conditions associated with a shared access credential are evaluated to determine whether the application is authorized to access the stored object. As described above, application 340 of FIG. 3 may desire to access object 316 at NBS service 104. Flowchart 200 may be performed, leading to steps 214, 216, and 218, where storage access manager 314 at NBS service 104 receives request 346 that includes replacement shared access credential 348. According to step 402 of FIG. 4, storage access manager 314 evaluates condition(s) 350 to determine whether application 340 can access stored object 316. If conditions(s) 350 do not prevent the requested type of access defined in request 346, storage access manager 314 may enable application 340 to access stored object 316, which may include proceeding to step 218 of FIG. 2 (providing stored object 318 to application 340). Otherwise, if storage access manager 314 determines conditions(s) 350 prevent the requested type of access defined in request 346, storage access manager 314 may deny access to stored object 316 (step 220 of FIG. 2).

For example, storage access manager 314 may operate according to FIG. 5. FIG. 5 is a flowchart 500 of a process of applying conditions for access to a stored object by a shared access credential, in accordance with another example embodiment. In an embodiment, flowchart 500 may be implemented during step 402 of FIG. 4. Note that any one or more of the steps of flowchart 500 may be performed, in any order, in embodiments, depending on the particular conditions associated with a shared access credential and corresponding stored object.

Flowchart 500 begins in step 502. In step 502, whether the stored object is being accessed from a specified network address is determined. In an embodiment, condition(s) 350 may include a network address (e.g., IP address) from which the stored object may be accessed. If request 346 for stored object 318 is received from the indicated network address, access to stored object 318 may be granted (subject to any other conditions). If request 346 is not from the indicated network address, the request is denied at step 510. Note that any number of acceptable network addresses may be indicated, and/or any number of disallowed network addresses may be indicated in condition(s) 350.

In step 504, whether a valid time interval for the shared access credential expired is determined. In an embodiment, condition(s) 350 may indicate a time interval over which shared access credential 348 is valid. The time interval may be expressed in any manner, including an expiry date/time, a length of time from issue, etc. If request 346 for stored object 318 is received within the indicate time interval, access to stored object 318 may be granted (subject to any other conditions). If request 346 is not received within the indicated time interval, the request is denied at step 510.

In step 506, whether the request involves a permission granted with respect to the stored object is determined. In an embodiment, condition(s) 350 may indicate one or more permissions that indicate which operations can performed by application 340 on stored object 318. As described above, the permissions can include read, write, delete, copy, and/or other permissions. If request 346 for stored object 318 is an access type deemed acceptable by the indicated permissions, access to stored object 318 may be granted (subject to any other conditions). If request 346 is as access type not deemed acceptable by the indicated permissions, the request is denied at step 510. Note that default permissions may be applied to stored object 318 by storage access manager 314 in the absence of conflicting permissions indicated in condition(s) 350.

In step 508, whether the stored object is being accessed over a specified protocol is determined. In an embodiment, condition(s) 350 may one or more communication protocols used by request 346. For example, one or both of HTTP (hypertext transfer protocol) and HTTPS (HTTP secure) can be indicated in condition(s) 350 as acceptable (or as unacceptable) access protocols. If request 346 for stored object 318 is received according to a communication protocol deemed acceptable by condition(s) 350, access to stored object 318 may be granted (subject to any other conditions). If request 346 is received according to a communication protocol not deemed acceptable, the request is denied at step 510.

Note that each condition may have defaults applied by storage access manager 314 in the absence of corresponding conditions being defined in condition(s) 350 that override.

Furthermore, as described herein, SAC manager 322 may monitor condition(s) 350 that indicate shared access credential 336 should be replaced with a new shared access credential. For example, SAC manager 322 may be configured to determine that a condition for replacement associated with shared access credential 336 is satisfied (e.g., A condition specifies a time interval over which shared access credential 336 is valid, and SAC manager 322 determined a predetermined portion of the time interval has passed, such that a replacement should be requested). In such case, SAC manager 322 may cause access manager 320 to provide to NBS service 104 a replacement request for replacement of shared access credential 336. In such case, SAC generator 312 may receive the replacement request, generate a replacement shared access credential 348, and transmit replacement shared access credential 336 to client 106. SAC manager 322 receives replacement shared access credential 348 for stored object copy 332 (copy of stored object 318 at NBS service 104) from SAC generator 312 at SAC service 102 or NBS service 104, and replaces shared access credential 336 with replacement shared access credential 348. Such shared access credential replacement may be performed in conjunction with a request for a stored object, or independent of a request for a stored object.

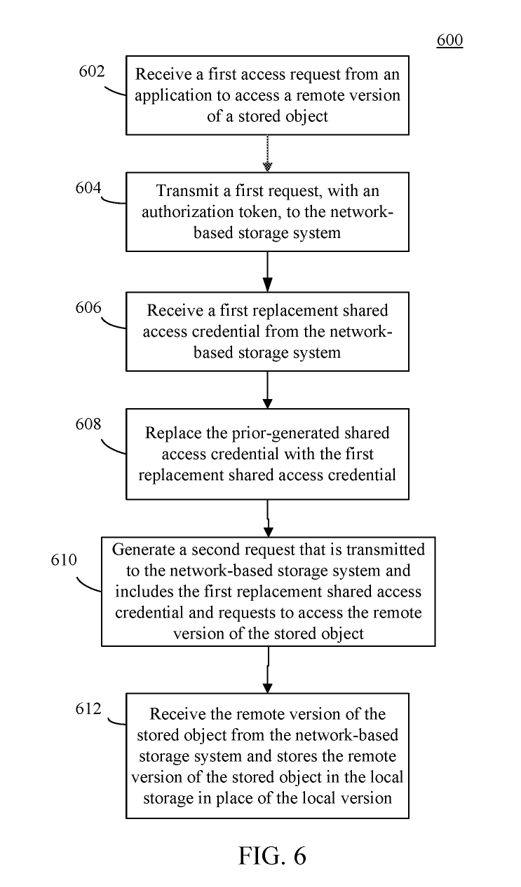

Note that flowchart 200 described above relates primarily to operations performed at SAC service 102 and NBS service 104. FIG. 6 shows a flowchart describing the analogous operations performed at client 106 during operation of flowchart 200. In particular, FIG. 6 is a flowchart 600 of a client-side process for requesting a replacement shared access credential, in accordance with an example embodiment. Flowchart 600, for example, can be performed by client 106. Flowchart 600 is described as follows.

In step 602, a first access request is received from an application to access a remote version of a stored object. For example, access manager 320 (FIG. 3) may receive a request for stored object 318 from application 340, as described in further detail elsewhere herein.

In step 604, a first request is transmitted with an authorization token to the network-based storage system. Step 604 can, for example, be performed by access manager 320 of client 106 of FIG. 3 as described in more detail herein. As shown in FIG. 3, access manager 320 transmits request 342, which includes authorization token 334. Authorization token 340 may optionally include condition(s) 350.

In step 606, a first replacement shared access credential is received from the network-based storage system. Step 606 can, for example, be performed by access manager 320 of client 106 of FIG. 3 as described in more detail herein. As shown in FIG. 3, access manager 320 may receive replacement shared access credential 348 in response to request 342.

In step 608, the prior-generated shared access credential is replaced with the first replacement shared access credential. Step 608 can, for example, be performed by SAC manager 322 of client 106 of FIG. 3. SAC manager 322 may store replacement shared access credential 348 in local storage 330, and delete shared access credential 336.

In step 610, a second request is generated that is transmitted to the network-based storage system and includes the first replacement shared access credential and requests to access the remote version of the stored object. Step 610 can, for example, be performed by access manager 320. As shown in FIG. 3, access manager 320 may transmit request 346 to NBS service 104. Request 346 is a request for stored object 318 and includes replacement shared access credential 348.

In step 612, the remote version of the stored object is received from the network-based storage system and stores the remote version of the stored object in the local storage in place of the local version. Step 612 can, for example, be performed by access manager 320. As shown in FIG. 3, access manager 320 receives access request response 344, which includes stored object 318 (assuming any of condition(s) 350, if associated with replacement shared access credential 348, are not violated).

In this manner, stored objects may be synched between storage locations in a secure manner through the use of shared access credentials, which can be configured with default and/or custom conditions, such as expiration time intervals, acceptable network addresses, etc. Such conditions limit access to stored objects, thereby preventing undesired entities that obtain a copy of a shared access credential from being able to access the corresponding stored object(s). For example, a shared access credential may expire in various short time intervals (e.g., milliseconds), so an undesired entity obtaining one may be unable to use it. Alternatively, the undesired entity may attempt to use the shared access credential from a disallowed network address, using a disallowed communication protocol, and/or violating a disallowed permission, each of which protect the corresponding stored object(s) from such undesired access.

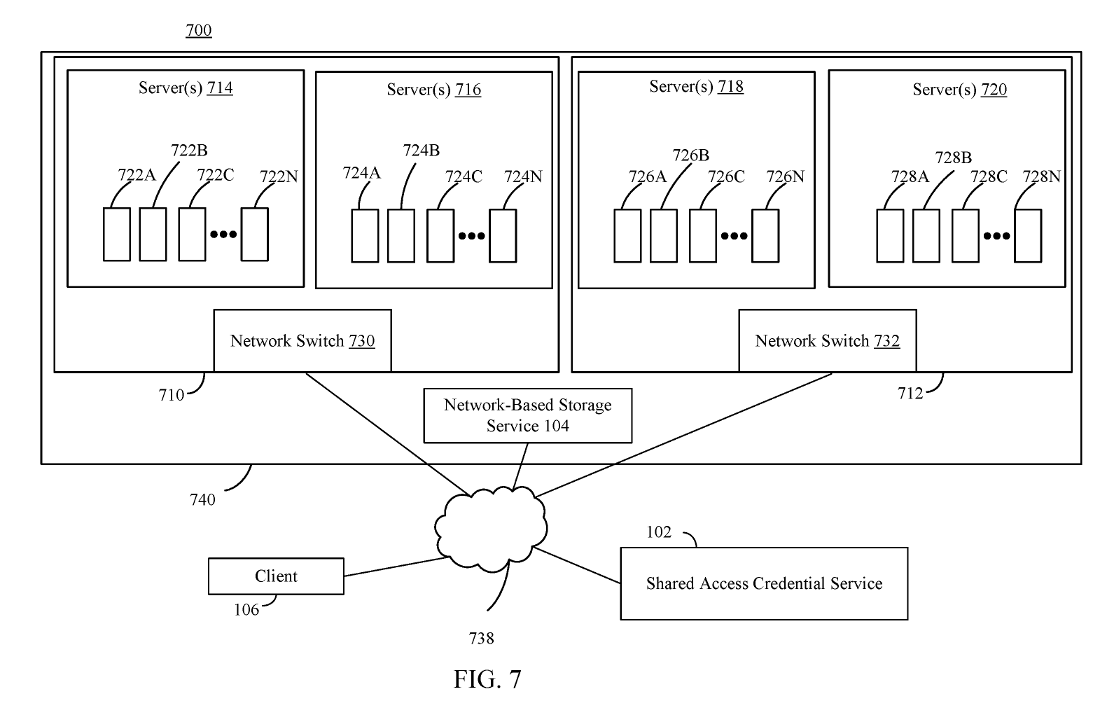

Note that embodiments may be implemented in a variety of storage system types. For instance, FIG. 7 shows a network-based storage system 700 configured for managing access to stored objects, in accordance with an example embodiment. As shown in FIG. 7, system 700 includes client 106, SAC service 102, and a network-accessible server infrastructure 740 that includes NBS service 104. Network-accessible server infrastructure 740 further includes a plurality of resource sets 710 and 712. Resource sets 710 and 712, client 106, NBS service 106, and SAC service 102 are communicatively coupled via a network 738. Network 738 may comprise one or more networks such as local area networks (LANs), wide area networks (WANs), enterprise networks, the Internet, etc., and may include one or more of wired and/or wireless portions.

Resource sets 710 and 712 may form a network-accessible server set, such as a cloud computing server network defined by network-accessible server infrastructure 740. For example, each of resource sets 710 and 712 may comprise a group or collection of servers (e.g., computing devices) that are each accessible by a network such as the Internet (e.g., in a “cloud-based” embodiment) to store, manage, and process data. As shown in the exemplary embodiment of FIG. 7, resource set 710 includes server(s) 714 and 716, and resource set 712 includes server(s) 718 and 720. Each of server(s) 714, 716, 718 and 720 may comprise any number of servers that are configured to host and execute one or more computing resources (e.g., computer networks, servers, storage, applications and services). For example, server(s) 714 may include servers 722A-722N, server(s) 716 may include servers 724A-724N, server(s) 718 may include servers 726A-726N, and server(s) 720 may include servers 728A-728N, where N is any integer greater than 1.

Resource sets 710 and 712 may include any type and number of other computing resources, including resources that facilitate communications with and between the servers (e.g., network switches, networks, etc.), storage by the servers (e.g., storage devices, etc.), resources that manage other resources (e.g., hypervisors that manage virtual machines to present a virtual operating platform for tenants of network-accessible server infrastructure 740, etc.), and/or further types of resources. Servers of a resource set may be organized in any manner, including being grouped in server racks (e.g., 8-40 servers per rack, referred to as nodes or “blade servers”), server clusters (e.g., 2-64 servers, 4-8 racks, etc.), or datacenters (e.g., thousands of servers, hundreds of racks, dozens of clusters, etc.). In an embodiment, the servers of a resource set may be co-located (e.g., housed in one or more nearby buildings with associated components such as backup power supplies, redundant data communications, environmental controls, etc.) to form a datacenter, or may be arranged in other manners. Accordingly, in an embodiment, resource sets 710 and 712 may each be a datacenter in a distributed collection of datacenters.

In accordance with such an embodiment, each of resource sets 710 and 712 may be configured to service a particular geographical region. For example, resource set 710 may be configured to service the northeastern region of the United States, and resource set 712 may be configured to service the southwestern region of the United States. It is noted that the network-accessible server set may include any number of resource sets, and each resource set may service any number of geographical regions worldwide.

Note that the variable “N” is appended to various reference numerals identifying illustrated components to indicate that the number of such components is variable, for example, with any value of 2 and greater. Note that for each distinct component/reference numeral, the variable “N” has a corresponding value, which may be different for the value of “N” for other components/reference numerals. The value of “N” for any particular component/reference numeral may be less than 10, in the 10s, in the hundreds, in the thousands, or even greater, depending on the particular implementation.

Each of server(s) 714, 716, 718, 720 may be configured to execute one or more services (including microservices), applications, and/or supporting services. As shown in FIG. 7, server(s) 714, 716, 718, 720 may each be configured to execute supporting services. A “supporting service” is a cloud computing service/application configured to manage a set of servers (e.g., a cluster of servers in servers 710) to operate as network-accessible (e.g., cloud-based) computing resources for users. Examples of supporting services include Microsoft® Azure®, Amazon Web Services™, Google Cloud Platform™, IBM® Smart Cloud, etc. A supporting service may be configured to build, deploy, and manage applications and services on the corresponding set of servers. Each instance of the supporting service may implement and/or manage a set of focused and distinct features or functions on the corresponding server set, including virtual machines, operating systems, application services, storage services, database services, messaging services, etc. Supporting services may be coded in any programming language. Each of server(s) 714, 716, 718, 720 may be configured to execute any number of supporting services, including multiple instances of the same and/or different supporting services.

In FIG. 7, client 106 may be a computing device of a user of SAC service 102 (e.g., individual users, family users, enterprise users, governmental users, etc.) that may be a tenant of and/or that otherwise access network-accessible resource sets 710 and 712 for computing resources over network 738. Any number of clients 106 may be present in system 700, including tens, hundreds, thousands, millions, or even greater numbers. Each client 106 may interface with server(s) 714, 716, 718, 720 through application programming interfaces (APIs) and/or by other mechanisms.

As described above, SAC service 102 receives authorization tokens from client(s) 106, and generates (or causes to be generated by NBS service 104) shared access credentials that can be used to access stored objects at NBS service 104. NBS service 104 is configured to manage requests from client(s) 106 for access to stored objects via the shared access credentials. Any number of NBS services 104 may be present in network-accessible server infrastructure 740, such as one or more per resource set, one or more per server, etc. Furthermore, note that SAC service 102 may be separate from network-accessible server infrastructure 740, as shown in FIG. 7, or may included in network-accessible server infrastructure 740 (e.g., executing in one or more servers of a server set).

### Example Computer System Implementation

Any of the components of system 100, system 108, system 300, and system 700 and the steps of flowcharts 200, 400, 500, and 600 may be implemented in hardware, or hardware with any combination of software and/or firmware, including being implemented as computer program code configured to be executed in one or more processors and stored in a computer readable storage medium, or being implemented as hardware logic/electrical circuitry, such as being implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

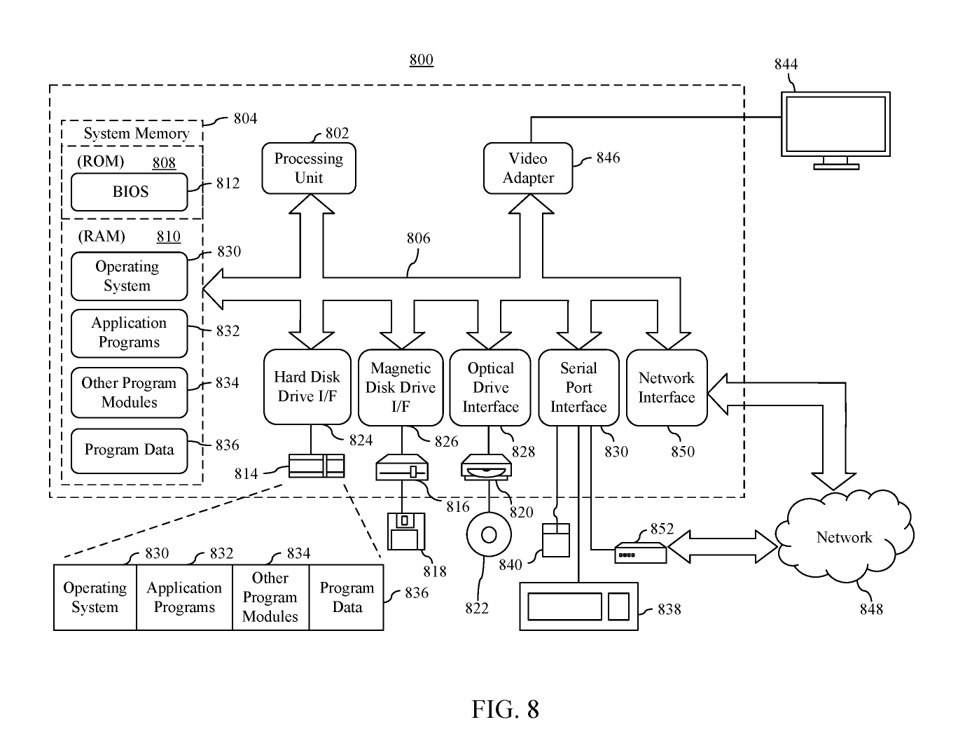

FIG. 8 depicts an example processor-based computer system 800 that may be used to implement various embodiments described herein, including client 106, shared access credential service 102, network-based storage service 104, servers 714, 716, 718 and 720, etc. System 800 may also be used to implement any or all the steps of flowcharts 200, 400, 500, and 600. The description of system 800 provided herein is provided for purposes of illustration, and is not intended to be limiting. Embodiments may be implemented in further types of computer systems, as would be known to persons skilled in the relevant art(s).

As shown in FIG. 8, system 800 includes a processing unit 802, a system memory 804, and a bus 806 that couples various system components including system memory 804 to processing unit 802. Processing unit 802 may comprise one or more microprocessors or microprocessor cores. Bus 806 represents one or more of any of several types of bus structures, including a memory bus or memory controller, a peripheral bus, an accelerated graphics port, and a processor or local bus using any of a variety of bus architectures. System memory 804 includes read only memory (ROM) 808 and random-access memory (RAM) 810. A basic input/output system 812 (BIOS) is stored in ROM 808.

System 800 also has one or more of the following drives: a hard disk drive 814 for reading from and writing to a hard disk, a magnetic disk drive 816 for reading from or writing to a removable magnetic disk 818, and an optical disk drive 820 for reading from or writing to a removable optical disk 822 such as a CD ROM, DVD ROM, BLU-RAY™ disk or other optical media. Hard disk drive 814, magnetic disk drive 816, and optical disk drive 820 are connected to bus 806 by a hard disk drive interface 824, a magnetic disk drive interface 826, and an optical drive interface 828, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules or components may be stored on the hard disk, magnetic disk, optical disk, ROM, or RAM. These program modules include an operating system 830, one or more application programs 832, other program modules 834, and program data 836. In accordance with various embodiments, the program modules may include computer program logic that is executable by processing unit 802 to perform any or all the functions and features of system 100 of FIG. 1 and system 300 of FIG. 3 as described above. The program modules may also include computer program logic that, when executed by processing unit 802, performs any of the steps or operations shown or described in reference to the flowcharts of FIGS. 2 and 4-6.

A user may enter commands and information into system 800 through input devices such as a keyboard 838 and a pointing device 840. Other input devices (not shown) may include a microphone, joystick, game controller, scanner, or the like. In one embodiment, a touch screen is provided in conjunction with a display 844 to allow a user to provide user input via the application of a touch (as by a finger or stylus for example) to one or more points on the touch screen. These and other input devices are often connected to processing unit 802 through a serial port interface 842 that is coupled to bus 806, but may be connected by other interfaces, such as a parallel port, game port, or a universal serial bus (USB). Such interfaces may be wired or wireless interfaces.

A display 844 is also connected to bus 806 via an interface, such as a video adapter 846. In addition to display 844, system 800 may include other peripheral output devices (not shown) such as speakers and printers.

System 800 is connected to a network 848 (e.g., a local area network or wide area network such as the Internet) through a network interface or adapter 850, a modem 852, or other suitable means for establishing communications over the network. Modem 852, which may be internal or external, is connected to bus 806 via serial port interface 842. As used herein, the terms “computer program medium,” “computer-readable medium,” and “computer-readable storage medium” are used to generally refer to memory devices or storage structures such as the hard disk associated with hard disk drive 814, removable magnetic disk 818, removable optical disk 822, as well as other memory devices or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 832 and other program modules 834) may be stored on the hard disk, magnetic disk, optical disk, ROM, or RAM. Such computer programs may also be received via network interface 850, serial port interface 842, or any other interface type. Such computer programs, when executed or loaded by an application, enable system 800 to implement features of embodiments of the present methods and systems described herein. Accordingly, such computer programs represent controllers of the system 800.

Embodiments are also directed to computer program products comprising software stored on any computer useable medium. Such software, when executed in one or more data processing devices, causes a data processing device(s) to operate as described herein. Embodiments of the present methods and systems employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

### Additional Exemplary Embodiments

The example embodiments described herein are provided for illustrative purposes, and are not limiting. The examples described herein may be adapted to any type of system or method. Further structural and operational embodiments, including modifications/alterations, will become apparent to persons skilled in the relevant art(s) from the teachings herein.

In an embodiment, a system in at least one server for managing access to a stored object, comprising: one or more memory devices configured to store program logic; and one or more processors operable to access the one or more memory devices and to execute the program logic, the program logic comprising: an authorization manager configured to receive a first request from a client, the first request including an authorization token, and to determine whether an application in the client is authorized to access the stored object based upon the authorization token; and a shared access credential generator configured to, in response to determining the application to be authorized to access the stored object based on the authorization token, generate a replacement shared access credential to replace a prior-generated shared access credential associated with the stored object and configured to be presented by the application to enable access to the stored object, associate the replacement shared access credential with the stored object, and provide the replacement shared access credential to the client.

In an embodiment, the program logic further comprises: a storage access manager configured to receive a second request from the client, the second request including the replacement shared access credential and attempting to access the stored object; determine the application is authorized to access the stored object based on the replacement shared access credential received in the second request; and enable access to the stored object by the application at the client.

In an embodiment, the storage access manager is further configured to: receive a third request from the client, the third request including the replacement shared access credential and attempting to access the stored object; determine the application is authorized to access the stored object based on the replacement shared access credential received in the third request; and enable access to the stored object by the application at the client.

In an embodiment, the authorization manager is further configured to: determine from the authorization token one or more conditions for the replacement shared access credential; and provide the one or more conditions to the storage access manager.

In an embodiment, the one or more conditions include at least one of: a time interval for which the replacement shared access credential is valid, a permission granted by the replacement shared access credential for access to the stored object, a network address from which the stored object may be accessed using the replacement shared access credential, or a communication protocol by which the stored object may be accessed using the replacement shared access credential.

In an embodiment, the storage access manager is configured to: receive a second request from the application at the client, the second request including the replacement shared access credential; evaluate the one or more conditions to determine whether the application is authorized to access the stored object.

In an embodiment, the shared access credential generator is configured to: receive a second request from the client, the second request including the authorization token; generate a second replacement shared access credential for the stored object to replace the prior-generated replacement shared access credential; and provide the second replacement shared access credential to the client.

In another embodiment, a method, in at least one server, for managing access to a stored object comprises: receiving a first request from a client, the first request including an authorization token; determining whether an application in the client is authorized to access the stored object based upon the authorization token; and in response to determining the application to be authorized to access the stored object based on the authorization token, generating a replacement shared access credential to replace a prior-generated shared access credential associated with the stored object and configured to be presented by the application to enable access to the stored object, associating the replacement shared access credential with the stored object, and providing the replacement shared access credential to the client.

In an embodiment, the method of further comprises: receiving a second request from the client, the second request including the replacement shared access credential and attempting to access the stored object; determining the application is authorized to access the stored object based on the replacement shared access credential received in the second request; and enabling access to the stored object by the application at the client.

In an embodiment, the method of further comprises: receiving a third request from the client, the third request including the replacement shared access credential and attempting to access the stored object; determining the application is authorized to access the stored object based on the replacement shared access credential received in the third request; and enabling access to the stored object by the application at the client.

In an embodiment, the method of further comprises: determining from the authorization token one or more conditions for the replacement shared access credential; and maintaining the one or more conditions at the at least one server.

In an embodiment, the determining from the authorization token one or more conditions for the replacement shared access credential comprises: determining the authorization token includes a condition of: a time interval for which the replacement shared access credential is valid, a permission granted by the replacement shared access credential for access to the stored object, a network address from which the stored object may be accessed using the replacement shared access credential, or a communication protocol by which the stored object may be accessed using the replacement shared access credential.

In an embodiment, the method of further comprises: receiving a second request from the application at the client, the second request including the replacement shared access credential; and evaluating the one or more conditions to determine whether the application is authorized to access the stored object.

In an embodiment, the method of further comprises: receiving a second request from the client, the second request including the authorization token; generating a second replacement shared access credential for the stored object to replace the prior-generated replacement shared access credential; and providing the second replacement shared access credential to the client.

In another embodiment, a remote storage access system in a client computing system, comprises: an access manager configured to manage access to local storage, the local storage storing a local version of an object that has a remote version stored at a network-based storage system, the local version of the stored object having an associated prior-generated shared access credential, the access manager configured to receive a first access request from an application to access the remote version of the stored object, to transmit a first request, with an authorization token, to the network-based storage system, and to receive a first replacement shared access credential from the network-based storage system; and a shared access credential manager configured to replace the prior-generated shared access credential with the first replacement shared access credential; and the access manager configured to generate a second request that is transmitted to the network-based storage system and includes the first replacement shared access credential and requests to access the remote version of the stored object; wherein the access manager receives the remote version of the stored object from the network-based storage system and stores the remote version of the stored object in the local storage in place of the local version.

In an embodiment, the access manager is further is configured to, in response to a second access from the application to access the stored object, and to generate a third request that is transmitted to the network-based storage system and includes the first replacement shared access credential and requests to access the remote version of the stored object; wherein the access manager receives a second instance of the remote version of the stored object from the network-based storage system and stores the second instance in the local storage.

In an embodiment, the shared access credential manager is further configured to: indicate in the authorization token one or more conditions for the replacement shared access credential.

In an embodiment, the one or more conditions include at least one of: a time interval for which the replacement shared access credential is valid, a permission granted by the replacement shared access credential for access to the stored object, a network address from which the stored object may be accessed using the replacement shared access credential, or a communication protocol by which the stored object may be accessed using the replacement shared access credential.

In an embodiment, the shared access credential manager is configured to: determine a condition for replacement associated with the first replacement shared access credential is satisfied; cause the access manager to provide to the network-based storage system a replacement request for a replacement of the first replacement shared access credential, and receive a second replacement shared access credential for the stored object from the network-based storage system; and replace the first replacement shared access credential with the second replacement shared access credential.

In an embodiment, the shared access credential manager is further configured to replace the prior-generated shared access credential with the first replacement shared access credential while providing uninterrupted access to the object by the application in a manner that is transparent to the application.

### CONCLUSION

While various embodiments of the present methods and systems have been described above, it should be understood that they have been presented by way of example only, and not limitation. It will be apparent to persons skilled in the relevant art that various changes in form and detail can be made therein without departing from the spirit and scope of the methods and systems. Thus, the breadth and scope of the present methods and systems should not be limited by any of the above-described exemplary embodiments, but should be defined only in accordance with the following claims and their equivalents.

What is claimed is:

1. A system in at least one server for managing access to a stored object, comprising:
one or more memory devices configured to store program logic; and
one or more processors operable to access the one or more memory devices and to execute the program logic, the program logic comprising:
an authorization manager configured to receive a first request from a client, the first request including an authorization token, and to determine whether an application in the client is authorized to access the stored object based upon the authorization token; and
a shared access credential generator configured to, in response to determining the application to be authorized to access the stored object based on the authorization token,
generate a replacement shared access credential to replace a prior-generated shared access credential associated with the stored object and configured to be presented by the application to enable access to the stored object,
associate the replacement shared access credential with the stored object, and
provide the replacement shared access credential to the client.

2. The system of claim 1, wherein the program logic further comprises:
a storage access manager configured to
receive a second request from the client, the second request including the replacement shared access credential and attempting to access the stored object;
determine the application is authorized to access the stored object based on the replacement shared access credential received in the second request; and
enable access to the stored object by the application at the client.

3. The system of claim 2, wherein the storage access manager is further configured to:
receive a third request from the client, the third request including the replacement shared access credential and attempting to access the stored object;
determine the application is authorized to access the stored object based on the replacement shared access credential received in the third request; and
enable access to the stored object by the application at the client.

4. The system of claim 2, wherein the authorization manager is further configured to:
determine from the authorization token one or more conditions for the replacement shared access credential; and
provide the one or more conditions to the storage access manager.

5. The system of claim 4, wherein the one or more conditions include at least one of:
a time interval for which the replacement shared access credential is valid,
a permission granted by the replacement shared access credential for access to the stored object,
a network address from which the stored object may be accessed using the replacement shared access credential, or
a communication protocol by which the stored object may be accessed using the replacement shared access credential.

6. The system of claim 4, wherein the storage access manager is configured to:
receive a second request from the application at the client, the second request including the replacement shared access credential;
evaluate the one or more conditions to determine whether the application is authorized to access the stored object.

7. The system of claim 1, wherein the shared access credential generator is configured to:
receive a second request from the client, the second request including the authorization token;
generate a second replacement shared access credential for the stored object to replace the prior-generated replacement shared access credential; and
provide the second replacement shared access credential to the client.

8. A method, in at least one server, for managing access to a stored object, comprising:
receiving a first request from a client, the first request including an authorization token;
determining whether an application in the client is authorized to access the stored object based upon the authorization token; and
in response to determining the application to be authorized to access the stored object based on the authorization token,
generating a replacement shared access credential to replace a prior-generated shared access credential associated with the stored object and configured to be presented by the application to enable access to the stored object, associating the replacement shared access credential with the stored object, and
providing the replacement shared access credential to the client.

9. The method of claim 8, further comprising:
receiving a second request from the client, the second request including the replacement shared access credential and attempting to access the stored object;
determining the application is authorized to access the stored object based on the replacement shared access credential received in the second request; and
enabling access to the stored object by the application at the client.

10. The method of claim 9, further comprising:
receiving a third request from the client, the third request including the replacement shared access credential and attempting to access the stored object;
determining the application is authorized to access the stored object based on the replacement shared access credential received in the third request; and
enabling access to the stored object by the application at the client.

11. The method of claim 8, further comprising:
determining from the authorization token one or more conditions for the replacement shared access credential; and
maintaining the one or more conditions at the at least one server.

12. The method of claim 11, wherein said determining from the authorization token one or more conditions for the replacement shared access credential comprises:
determining the authorization token includes a condition of:
a time interval for which the replacement shared access credential is valid,
a permission granted by the replacement shared access credential for access to the stored object,
a network address from which the stored object may be accessed using the replacement shared access credential, or
a communication protocol by which the stored object may be accessed using the replacement shared access credential.

13. The method of claim 11, further comprising:
receiving a second request from the application at the client, the second request including the replacement shared access credential; and
evaluating the one or more conditions to determine whether the application is authorized to access the stored object.

14. The method of claim 8, further comprising:
receiving a second request from the client, the second request including the authorization token;
generating a second replacement shared access credential for the stored object to replace the prior-generated replacement shared access credential; and
providing the second replacement shared access credential to the client.

15. A remote storage access system in a client computing system, comprising:
an access manager configured to manage access to local storage, the local storage storing a local version of an object that has a remote version stored at a network-based storage system, the local version of the stored object having an associated prior-generated shared access credential, the access manager configured to receive a first access request from an application to access the remote version of the stored object, to transmit a first request, with an authorization token, to the network-based storage system, and to receive a first replacement shared access credential from the network-based storage system; and
a shared access credential manager configured to replace the prior-generated shared access credential with the first replacement shared access credential; and
the access manager configured to generate a second request that is transmitted to the network-based storage system and includes the first replacement shared access credential and requests to access the remote version of the stored object;
wherein the access manager receives the remote version of the stored object from the network-based storage system and stores the remote version of the stored object in the local storage in place of the local version.

16. The remote storage access system of claim 15, wherein the access manager is further is configured to, in response to a second access from the application to access the stored object, and to generate a third request that is transmitted to the network-based storage system and includes the first replacement shared access credential and requests to access the remote version of the stored object;
wherein the access manager receives a second instance of the remote version of the stored object from the network-based storage system and stores the second instance in the local storage.

17. The remote storage access system of claim 15, wherein the shared access credential manager is further configured to:
indicate in the authorization token one or more conditions for the replacement shared access credential.

18. The remote storage access system of claim 17, wherein the one or more conditions include at least one of:
a time interval for which the replacement shared access credential is valid,
a permission granted by the replacement shared access credential for access to the stored object,
a network address from which the stored object may be accessed using the replacement shared access credential, or
a communication protocol by which the stored object may be accessed using the replacement shared access credential.

19. The remote storage access system of claim 15, wherein the shared access credential manager is configured to:
determine a condition for replacement associated with the first replacement shared access credential is satisfied;
cause the access manager to
provide to the network-based storage system a replacement request for a replacement of the first replacement shared access credential, and
receive a second replacement shared access credential for the stored object from the network-based storage system; and
replace the first replacement shared access credential with the second replacement shared access credential.

20. The remote storage access system of claim 15, wherein the shared access credential manager is further configured to replace the prior-generated shared access credential with the first replacement shared access credential while providing uninterrupted access to the object by the application in a manner that is transparent to the application.
